(19) United States
(12) Patent Application Publication
(10) Pub. No.: US 2016/0183347 A1
(43) Pub. Date: Jun. 23, 2016

(54) MULTI-MASTER 0-10V DIMMING CONTROLLER WITH REMASTERING CAPABILITY

(71) Applicant: LEVITON MANUFACTURING CO., INC., Melville, NY (US)

(72) Inventor: NATHANIEL MORRISON, TIGARD, OR (US)

(21) Appl. No.: 14/577,513

(22) Filed: Dec. 19, 2014

(51) Int. Cl. H05B 37/02

(52) U.S. Cl. CPC H05B 37/0209; H05B 37/0227; H05B 37/0281; H05B 37/0218

(57) ABSTRACT

A 0-10V dimming system includes at least two dimming controllers, at least one luminaire electrically connected to the dimming controllers, a control source connected to each of the dimming controllers, including a method to receive inputs about a dimming level, and a microcontroller coupled to each of the dimming controllers, the microcontroller configured to assert control of the dimming circuit over any other dimming controllers based upon the control source.

### BACKGROUND

Electronic light dimming control signaling systems may use a DC (direct current) voltage that varies between 0 and 10 volts. They are typically referred to as 0-10V controls. The lighting control voltage scales the output of the luminaire depending upon the voltage. At 10V of control, the luminaire will output 100% of its potential light output, and at 1V of control the luminaire will output its minimum light output. The dimming control may or may not have the ability to turn the fixture off completely.

Regardless of the exact nature of the dimming system, they typically have only one master that controls all luminaires in the system. The dimming system may have multiple masters, but generally the master setting the lowest light level receives priority as the master. This may be less than ideal as the last setting from one of the controllers may be the desired setting.

### SUMMARY

Embodiments here include a 0-10V dimming system having at least two dimming controllers, at least one luminaire electrically connected to the dimming controllers, a control source connected to each of the dimming controllers, including a method to receive inputs about a dimming level, and a microcontroller coupled to each of the dimming controllers, the microcontroller configured to assert control of the dimming circuit over any other dimming controllers based upon the control source.

### BRIEF DESCRIPTION OF THE DRAWINGS

FIG. 1 shows an exemplary layout of a space having multiple luminaires and dimming controllers.

FIG. 2 shows a block diagram of an exemplary embodiment of a dimming control circuit.

FIG. 3 shows an exemplary embodiment of the microcontroller in a dimming control circuit.

FIG. 4 shows an alternate exemplary embodiment of a dimming control circuit.

FIG. 5 shows a flowchart of an exemplary embodiment of a method of a controller taking control of a multi-master lighting bus.

### DETAILED DESCRIPTION OF THE EMBODIMENTS

Dimming controls allow users to control light levels in a space at levels beyond just on and off. One particular type of dimming control is referred to as 0-10V control and is described in ANSI C82.11 Annex A and IEC 60929 Annex E. When the control is set to 10V, the light level is at its highest. When the control is set to 1V, the light level is at its minimum. Control signals travel across a bus connected to the lighting fixtures, of which there may be several connected to the dimming circuit.

For purposes of this discussion, a dimming controller sets the voltage of the 0-10V dimming control system according to a source of control. This in turn communicates the desired dimming level to the luminaire Some examples of control sources are: a user interface, a photocell, a fixed or astronomical time clock, and an occupancy sensor.

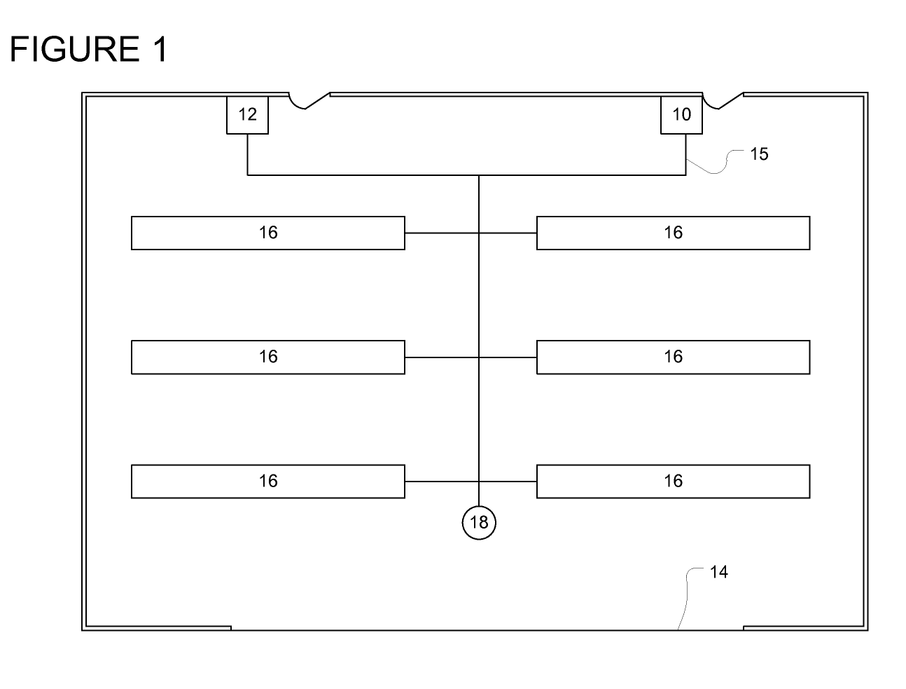

In current systems, there is typically one master dimming controller. In systems where there is more than one master, the master setting the lowest light level gets priority. FIG. 1 shows a space such as a conference room or other space having two or more dimming controllers for a dimming circuit that in turn control the luminaires for the space. In this particular example, specific references are made to controllers, fixtures, etc., for ease of discussion, and no limitation to any specific implementation or configuration is intended nor should any be implied.

In the space of FIG. 1, first and second dimming controllers 10 and 12 provide dimming control at the room entrances to the luminaires such as 16. The first and second controllers 10, 12 are electrically connected to the luminaires 16 by the lighting control bus 15. Similarly, there may be a photocell or occupancy sensor 18 also connected to lighting control bus 15 in order to adjust the dimming level as needed to maintain a particular level of lighting or meet building code requirements.

As shown in FIG. 1, the room may have a window 14 that provides ambient light from the outside. The photocell 18 may have override capabilities that will allow it to take control of the lighting level when the ambient light is at a high level due to outdoor light levels. In addition, the first and second dimming controllers 10, 12 may include a time clock to limit the maximum lighting level during certain periods of the day, or an occupancy sensor to control the lighting according to room occupancy. The desired lighting level, whether it comes from a user interface, the photocell, the time clock, or the occupancy sensor, will be referred to as the control source.

In a typical dimming system, assume a first user enters the space and uses the first dimming controller 10 to set the dimming level to 30%. If a second user were to enter the space and attempt to use the second dimming controller 12 to set the dimming level to a level higher than 30%, it would be ineffective. In current systems, the dimming controller that sets the light level to 30% remains master of the bus, because it was the first dimming controller to receive a light level input. The only way for the second dimming controller 12 to become the master controller would be if the second controller 12 were set to a dimming level lower than 30%. Otherwise, in order to change the lighting level the user would have to go back to the first controller 10.

It would be desirable in some dimming systems for the most recent dimming controller to be the master controller of the lighting control bus 15, rather than the dimming controller that sets the lowest light level to have priority. In the embodiments described herein, preferably the dimming controller that acted last gets priority. In the above scenario, when the second user used the second dimming controller 12 to enter a level higher than 30%, the second dimming controller 12 would become the master controller of the lighting control bus 15.

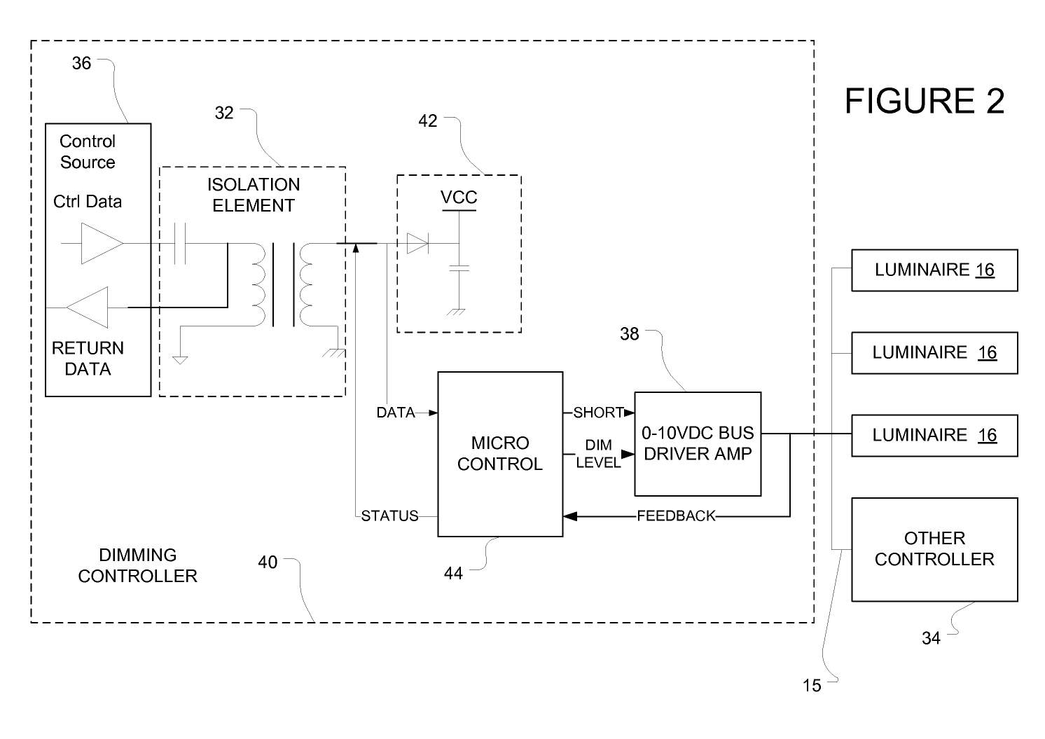

The components of the dimming controller 10, 12 may take many different forms, such as the isolation and control being needed because the microcontroller is powered by line voltage in some embodiments and powered by local power in others. FIG. 2 shows one possible implementation, but the embodiments herein are not intended to be limited to these elements.

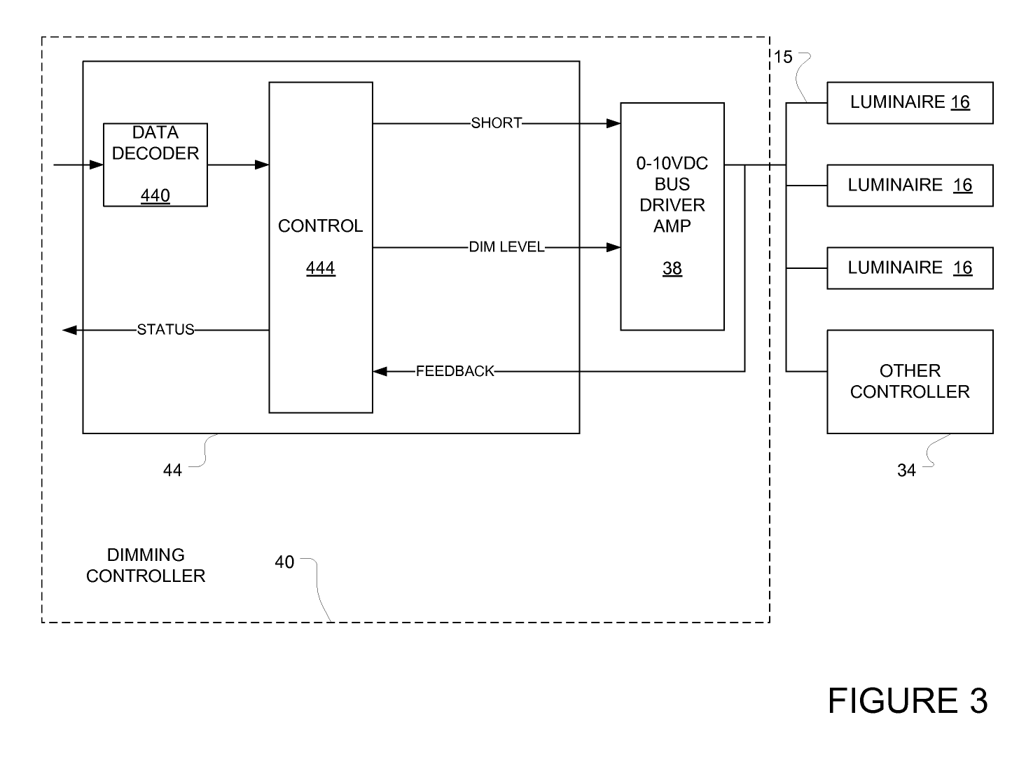

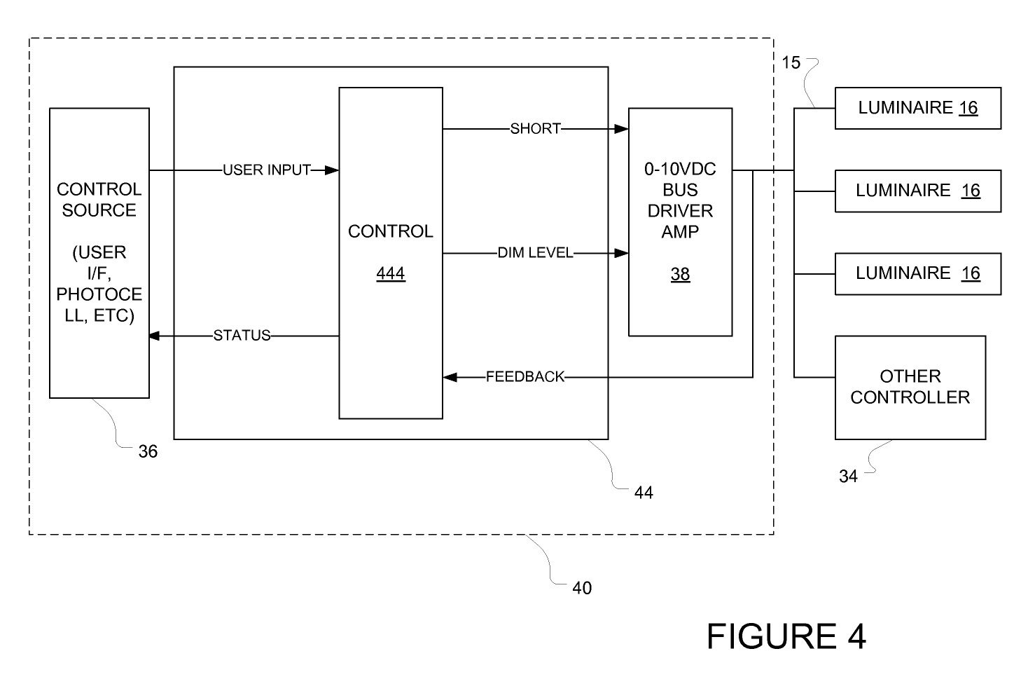

FIG. 2 shows an exemplary embodiment of a dimming controller 40. The dimming controller 40 may include a microcontroller 44 for communicating over an isolated interface with a control source 36. The dimming controller 40 receives the dimming level from the user, sends it to the microcontroller 44, which then handles bus control of the bus 15, and may transmit the return data back to the control source 36 indicating that it is or is not the master. As will be discussed in more detail with regard to FIGS. 3 and 4, the dimming controller 40 may or may not require isolation. The embodiment of FIG. 2 shows a dimming controller 40 with an optional isolation element as provided by a transformer 32, as well as an optional power supply 42.

The microcontroller 44 takes control of the bus when it receives the dimming level data signal from the control source 36 and holds it until any other controller wants control because it has received an input, such as from a user or a photocell, etc. The microcontroller 44 transmits the signal to the luminaire or luminaires 16 through the bus driver amplifier 38.

The microcontroller 44 may have several different components. FIG. 3 shows an exemplary embodiment of the microcontroller having isolation. Typically this is necessary because the dimming controller and the luminaires are all powered by the line voltage. In this embodiment, the microcontroller 44 preferably includes a data decoder 440 that decodes the dimming level data from the isolation circuit 32, and a control block 444 that further includes a control process or algorithm for controlling the dimming bus. The control block 444 may take many forms including, but not limited to, a dedicated microcontroller integrated circuit device, or a set of logic circuits that perform the functions of a microcontroller. The control block 444 may also take the form of instructions to be executed by the microcontroller. This process then outputs the dimming data to a bus driver amplifier 38. In addition, the feedback in combination with the data signal provides closed loop control of the output voltage.

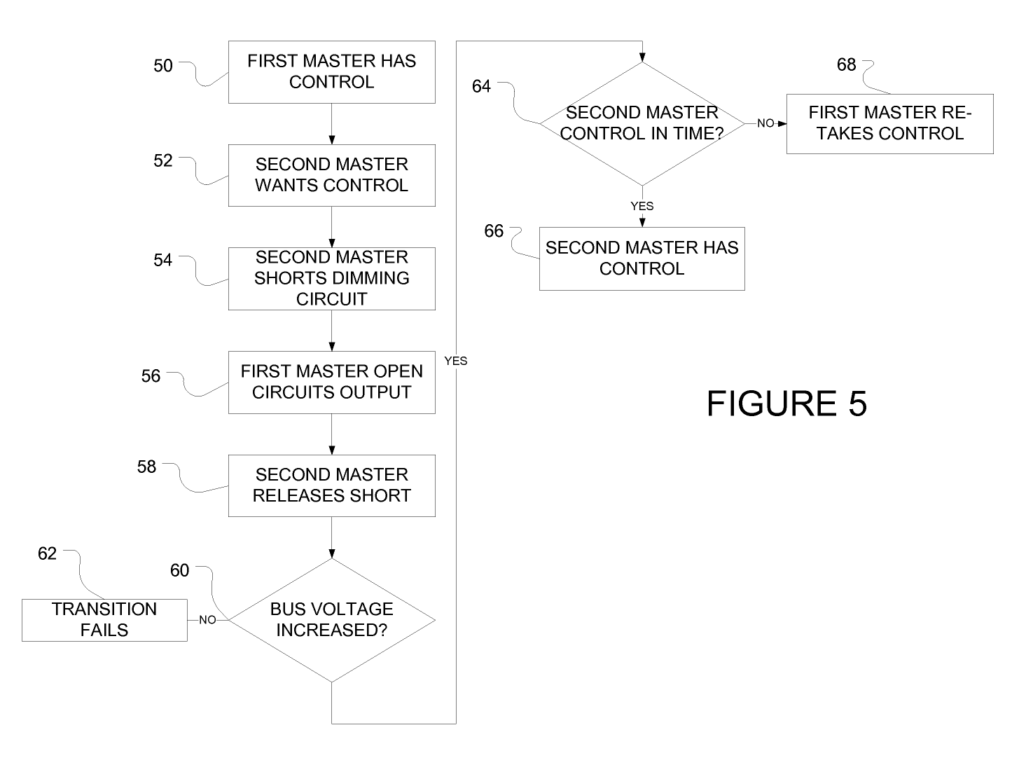

The process also may act to short the bus, as will be discussed with regard to FIG. 5. The short signal from the dimming controller 40 may also pass to the bus through the bus driver amplifier 38.

The luminaires 16 may have several dimming controllers electrically coupled to it such as 34, each one connected in different locations and performing different control functions, such as 10, 12, and 18 in FIG. 1. As mentioned previously, each dimming controller 34 or 40 is capable of taking control of the lighting control bus 15, as will be outlined in greater detail in connection with FIG. 5.

FIG. 4 shows an alternative exemplary embodiment of the dimming controller 40 in which isolation is not required. Without the need for isolation, the control source 36 and the microcontroller 44 can be implemented as one system microcontroller. In FIG. 4 the control source 36 is contained in the microcontroller 44. The dimming level is set in response to an input received from the control source 36. The input is provided to the control block 444, which sets the dim level and asserts the short or not to the bus driver amp 38. The luminaires 16 are connected to the dimming controller 40 and other controllers such as 34 as in other embodiments.

As mentioned previously, the embodiments illustrated in FIGS. 2, 3 and 4 are exemplary embodiments of a circuit that can take control of a dimming circuit in a multi-master system. FIG. 5 shows one embodiment of a process of a master in such a multi-master system, where a second master takes control of a dimming circuit that was previously under the control of another master. The process begins during a period of time when a first master has control of the dimming circuit at 50. The first master originally took control by completing the process below to assert itself as master.

As 52, a second master wants to take control because it has received an input. This will generally happen when a user activates a dimming controller other than the controller corresponding to the first master, for example, dimming controller 12 in our example described in connection with FIG. 1. This may also happen when automatic controls, such as for daylighting and other lumen control functions, wish to master the bus 15. Prior to taking control, the second master records the present voltage on the dimming circuit as part of taking control. The second master then begins to take control by shorting the dimming circuit at 54. When the second master shorts the dimming circuit, it does so for a brief amount of time, such as, for example, 200 microseconds. During the shorting interval, the dimming bus voltage is held to less than 0.5V. Also, as part of this process, the second master begins to calculate the integral of the 0-10V bus voltage, such as through a low pass filter.

At 56, the first master detects the short and open circuits its output. At 58 the second master releases the short. The bus voltage then increases to 12-18V using the pull-ups present in the luminaires. At 60 if the voltage level does not increase at least 1V above the previous dimming level, then the first master has locked the dimming bus and the master transition fails at 62. The master transition fails and the second master can retry after some delay or default to a lowest-takes-precedence mode similar to present embodiments of the 0-10 VDC control. The master transition may fail because an incompatible controller has been installed, such as one that is not multi-master capable, or an automatic control such as a photocell or occupancy sensor has locked the bus so it cannot be overridden.

After the second master releases the short at 58 and the voltage has risen more than 1V above the dimming level as described previously at 60, it leaves the bus open-circuit until the integrator indicates an average voltage equal to the previously-recorded voltage of the 0-10V dimming circuit at 60. This is done to avoid perturbing the lighting level during the master transition. The lighting loads have a low pass filter or no filter, and the transition time is brief such that it would be preferably imperceptible to the human eye under either condition. The first master performs the same integration in parallel. If the second master fails to take control within some time at 64, for example 120% of the expected result, the first master takes, or re-takes, control at 68 and the master transition fails. Otherwise, the second master takes control at 66 and the master transition is successful.

Upon taking control, the second master's microcontroller sends master status back to its controller and may then change the voltage on the 0-10V dimming circuit according to its control source, starting at the present voltage. The first master's microcontroller then preferably transmits a ‘not master’ status back to its control source.

As a modification, the process could use established voltage levels instead of short and open. For example, the controller requesting master status could reduce the bus voltage by 2V, if more than 3V on the bus, or shorting, if less than 3V on the bus, instead of always shorting. The process then increases the voltage to 1V above the previous level, if less than 3V on the bus, or 1V below, if greater than 3V on the bus, instead of opening as described above. This may result in less voltage swing and potentially less light source interaction during re-mastering. The reduced voltage level, or short, is a first threshold. The increased threshold, or open, is a second threshold.

In this manner, a dimming circuit may be controlled by one of many masters, and the master that had control last is the master of the dimming circuit, rather than the master that has the lowest light level. A provision for locking the bus by automatic controls is also provided.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the embodiments here.

1. A 0-10V dimming system, comprising:
a first and a second dimming controller;
at least one luminaire electrically connected to the dimming controllers;
a control source input connected to each of the dimming controllers to provide a dimming level; and
a first microcontroller coupled to the first dimming controller and a second microcontroller coupled to the second dimming controllers the microcontrollers configured to assert control of the dimming circuit over any other dimming controllers based upon the control source input via reducing, by the second controller, a voltage level on a bus below a first threshold and determining, by the first controller, that the voltage level on the bus has dropped below the first threshold.

2. The dimming system of claim 1, further comprising a bus driver amplifier.

3. The dimming system of claim 1, wherein the control source input comprises one of a user interface, a photocell interface, an occupancy sensor interface, or a time clock interface.

4. The dimming system of claim 1, wherein the microcontroller comprises one of a dedicated microcontroller device or a logic circuit.

5. The dimming system of claim 1, further comprising isolation between the control source input and the dimming microcontroller.

6. The dimming system of claim 1, wherein the luminaires and the dimming controllers are connected to a line voltage.

7. The dimming system of claim 1, wherein the dimming microcontrollers are connected to a local power supply.

8. A method, comprising:
initiating, by a second master, taking control of a dimming circuit from a first master;
recording, by the second master, a present voltage level on the bus;
reducing, by the second master, the voltage level on the bus below a first threshold;
allowing the voltage level on the bus to rise above the first threshold;
putting the bus in an open circuit state until an average voltage equals the present level; and
transitioning control to the second master.

9. The method of claim 8, wherein reducing the voltage level on the bus below a first threshold comprises shorting the bus.

10. The method of claim 8, wherein reducing the voltage level on the bus below a first threshold comprises reducing the voltage level on the bus below 0.5 V.

11. The method of claim 8, wherein allowing the voltage level on the bus to rise above the first threshold comprises open-circuiting the bus.

12. The method of claim 8, wherein allowing the voltage level on the bus to rise above a threshold comprises:
determining, by the second master, that the voltage on the bus has not risen above a predetermined level; and
failing transition to the second master.

13. The method of claim 8, wherein putting the bus in an open circuit state comprises:
determining, by the first master, that the second master has not taken control of the bus during a predetermined time period; and
failing transition to the second master.

14. A method, comprising:
initiating, by a second master, taking control of a dimming circuit from a first master;
reducing, by the second master, the voltage level on the bus below a first threshold;
determining, by the first master, the voltage level on the bus has dropped below the first threshold; and
transitioning control to the second master.

15. The method of claim 14, further comprising recording, by the second master, a present voltage level on the bus.

16. The method of claim 14, wherein reducing the voltage level on the bus below a first threshold comprises shorting the bus.

17. The method of claim 14, wherein reducing the voltage level on the bus below a first threshold comprises reducing the voltage level on the bus below 0.5 V.

18. The method of claim 14, wherein allowing the voltage level on the bus to rise above the first threshold comprises open-circuiting the bus.

19. The method of claim 14, wherein allowing the voltage level on the bus to rise above a threshold comprises:
determining, by the second master, that the voltage on the bus has not risen above a predetermined level; and
failing transition to the second master.

20. The method of claim 14, wherein putting the bus in an open circuit state comprises:
determining, by the first master, that the second master has not taken control of the bus during a predetermined time period; and
failing transition to the second master.
